(19) United States
(12) Patent Application Publication
(10) Pub. No.: US 2009/0200687 A1
(43) Pub. Date: Aug. 13, 2009

(54) TREATMENT SYSTEM FOR LIQUID

(76) Inventor: Ross A. Oades, Winnipeg (CA)

Correspondence Address: ADE & COMPANY INC., 2157 Henderson Highway, WINNIPEG, MB, R2G1P9, CA

(21) Appl. No.: 12/361,746

(22) Filed: Jan. 29, 2009

Related U.S. Application Data
(60) Provisional application No. 61/026,765, filed on Feb. 7, 2008.

(51) Int. Cl. B01F 3/04; C02F 3/20; C02F 3/22

(52) U.S. Cl. 261/27; 261/30; 261/28

(57) ABSTRACT

An aeration tank used in a method of treating effluent includes a pipe for transporting the effluent from the source to the tank bottom and a discharge duct having a siphon effect for tapping off an overflow from the tank as more effluent is added from the source. An array of air diffusion members is located in the center of the tank. Above each of the air diffusion members is provided a collector guide surface which collects bubbles as they get too large and channels them to outwardly from the center into a honeycomb filter medium formed in part annular members around the center. The filter medium receives the air and directs it back into the center around the guide surface to act as a growth medium for a biomass of bacteria.

This application claims the benefit under 35 U.S.C.119 of the filing date of Provisional Application 61/026,765 filed Feb. 7, 2008.

This invention relates to a treatment system for liquids including but not limited to water for treatment of water in the form of effluent or waste water where aeration for oxidation is required.

### BACKGROUND OF THE INVENTION

Treatment of effluent for example sewage or waste from one or more homes requires careful attention to prevent ground contamination. Conventionally septic tanks are widely used in conjunction with a septic field. However these require extensive land use and thus can only be used in areas where sufficient land is available.

City sewage treatment plants are relatively expensive. Simple lagoons have become environmentally unacceptable.

Systems which utilize aeration of the effluent are disclosed in U.S. Pat. No. 6,224,041 (Rebori) issued May 1, 2001 and in U.S. Pat. No. 6,554,996 by the same inventor issued Apr. 29, 2003, both patents being assigned to Bio-Microbics Inc.

These systems utilize a primary tank for receiving the sewage material, an aeration tank in which the effluent is vigorously aerated and a storage tank prior to discharge of the treated material. Further details of this arrangement are shown in literature provided by the above company.

While these arrangements provide an effective treatment, the construction is relatively expensive utilizing a proprietary aeration system. Much of the remainder of the system is however well known and the disclosures of the above patents are incorporated herein by reference for information relating to the general field with which the present invention is concerned.

In POT published application 2006/050600 by the present inventor published May 18, 2006 and now issued on Oct. 17, 2006 as U.S. Pat. No. 7,121,532 is disclosed an aeration tank used in a method of treating effluent includes a pipe for transporting the effluent from the source to the tank bottom and a discharge duct having a siphon effect for tapping off an overflow from the tank as more effluent is added from the source. An array of generally horizontal pipes is located in the tank having a series of exit holes along their length and connected to an air plenum at one side wall for feeding air into the end of each of the pipes, the pipes being arranged in columns one above another such that the air escapes from the pipes of the array through the holes to inject air into the effluent in the tank at positions spaced transversely, longitudinally and vertically. The pipes have flat upper discharge surfaces. Above each pipe is provided a collector channel which collects bubbles as they get too large and channels them to one end to be replaced by fresh small bubbles from a next above pipe.

### SUMMARY OF THE INVENTION

It is one object of the invention to provide an improved apparatus for treating waste liquid.

According to one aspect of the invention there is provided an apparatus for aeration of liquid comprising:

a tank for receiving the liquid from a source having a tank top, a tank bottom and tank sides for receiving and containing a quantity of the liquid during aeration;

the tank having a receiving section adjacent the tank bottom and a discharge section adjacent the tank top;

a liquid supply pipe for transporting the liquid from the source into the tank arranged to discharge the liquid into the receiving section adjacent the tank bottom;

a discharge duct for removing liquid from a top of the tank to maintain a desired level of the liquid in the tank;

at least one air diffusion member in the tank above the receiving section and below the level of the liquid so that said at least one air diffusion member is located in the liquid in the tank;

an air feed system including an air pump and air supply line for feeding air into said at least one air diffusion member for discharge of the air into the liquid as bubbles of the air in the liquid;

at least one collecting member arranged to collect and guide bubbles rising from said at least one air diffusion member;

and at least one trickle filter medium arranged to contain a biomass, the filter medium being arranged in the tank at a location therein to receive the air bubbles from said at least one air diffusion member guided by the collecting member.

Preferably the filter medium is formed of polyethylene.

Preferably the filter medium is arranged along at least one side of the tank. This can be only one side of a rectangular tank or may be more than one side of such a tank. Also the filter medium may be arranged at all sides surrounding a center area. In this case the tank may be rectangular in plan but preferably is circular in plan since such cylindrical tanks are more structurally suitable.

Preferably at least one of the air diffusion members is located in the tank above a bottom collecting member so as to discharge the air as bubbles into the liquid from which the bubbles of bottom one of the diffusion members have been removed by the bottom collecting member.

Preferably the at least one air diffusion member comprises a discharge mouth covered by a porous membrane through which the air escapes as bubbles. However other types of air diffusion members may be used including perforated pipes and pans where the air escapes through holes rather than through a membrane.

Preferably the collecting member is arranged to direct the collected air to each side of the tank so as to be directed to each part of the surrounding filter medium. However the single sided or multiple sided rectangular tank can also be used.

Preferably each collecting member is defined by an underside of a transverse sheet extending across the tank.

Preferably there is provided a series of air diffusion members arranged one above the next with each having an associated one of the collecting members above. The number can be varied depending on the capacity of the tank and the amount of liquid to be treated. In some cases only a single diffuser is necessary.

Preferably the air diffusion member or stack of such members is arranged in a center area with the cylindrical filter medium arranged to surround the center area.

Preferably when used with a cylindrical tank, the air diffusion member is circular and defines a circular center area.

Preferably the collecting member is arranged to direct air bubbles and liquid into the surrounding filter medium which is then driven back out of the filter medium above the collecting member back into the center area in a labyrinthine flow so that the liquid passes back and forth to be treated. Also the air flow into the filter medium and the biomass carried thereby ensures proper aeration of the biomass.

Preferably the filter medium includes a stack of part cylindrical members arranged one on top of the next to form a construction which can be easily assembled.

Preferably the other members defining the medium have vertical holes for passage of an air supply duct to the air diffusion members and the liquid supply pipe to the bottom of the tank.

Preferably there is provided a bottom pump out pipe extending from the receiving section at the bottom of the tank and at least one pressure cleaning pipe extending to the receiving section.

Preferably the pressure cleaning pipe has a directional nozzle which can be adjusted manually from the top of the tank by rotating the cleaning pipe around its axis.

Preferably the tank is arranged to receive a batch of liquid for treatment from the source which batch is communicated through the supply pipe to the receiving section and wherein there is provided a recirculation system including a recirculation pump for collecting liquid from the discharge section and returning it to the receiving section.

Preferably there is provided a timer responsive to the supply of a batch of liquid and arranged to time operation of the recirculation pump and the air pump for a pre-determined time period.

Preferably the recirculation system includes a return supply system arranged to effect discharge at positions around the receiving section.

Preferably there is provided a support floor for the trickle filter medium located above the receiving section.

Preferably there is provided a chemical injection system for supplying treatment chemicals into the supply pipe.

Preferably the treatment chemicals comprise ferric oxide.

Preferably there are provided back check valves in the air supply line at the air diffusion member.

According to a second aspect of the invention there is provided an apparatus for aeration of liquid comprising.

a tank for receiving the liquid from a source having a tank top, a tank bottom and tank sides for receiving and containing a quantity of the liquid during aeration;

the tank having a receiving section adjacent the tank bottom and a discharge section adjacent the tank top;

a liquid supply pipe for transporting the liquid from the source into the tank arranged to discharge the liquid into the receiving section adjacent the tank bottom;

a discharge duct for removing liquid from a top of the tank to maintain a desired level of the liquid in the tank;

at least one air diffusion member in the tank above the receiving section and below the level of the liquid so that said at least one air diffusion member is located in the liquid in the tank;

an air feed system including an air pump and air supply line for feeding air into said at least one air diffusion member for discharge of the air into the liquid as bubbles of the air in the liquid;

and at least one trickle filter medium arranged to contain a biomass;

wherein the at least one air diffusion member is arranged in a center area of the tank with the trickle filter medium surrounding the center area.

According to a third aspect of the invention there is provided an apparatus for aeration of liquid comprising:

a tank for receiving the liquid from a source having a tank top, a tank bottom and tank sides for receiving and containing a quantity of the liquid during aeration;

the tank having a receiving section adjacent the tank bottom and a discharge section adjacent the tank top;

a liquid supply pipe for transporting the liquid from the source into the tank arranged to discharge the liquid into the receiving section adjacent the tank bottom;

a discharge duct for removing liquid from a top of the tank to maintain a desired level of the liquid in the tank;

at least one air diffusion member in the tank above the receiving section and below the level of the liquid so that said at least one air diffusion member is located in the liquid in the tank;

an air feed system including an air pump and air supply line for feeding air into said at least one air diffusion member for discharge of the air into the liquid as bubbles of the air in the liquid;

wherein the tank is arranged to receive a batch of liquid for treatment from the source which batch is communicated through the supply pipe to the receiving section and wherein there is provided a recirculation system including a recirculation pump for collecting liquid from the discharge section and returning it to the receiving section.

### BRIEF DESCRIPTION OF THE DRAWINGS

One embodiment of the invention will now be described in conjunction with the accompanying drawings in which:

FIG. 1 is a vertical side elevational view showing internal components in phantom of an aeration tank according to the present invention.

FIG. 2 is a cross sectional view along the lines 2-2 of the tank of FIG. 1.

FIG. 3 is a cross sectional view along the lines 3-3 of the tank of FIG. 1.

FIG. 4 is a side elevational view of the aeration system of the embodiment of FIG. 1 extracted from the tank.

FIG. 5 is a side elevational view of one diffuser of the aeration system of the embodiment of FIG. 1 extracted from the tank.

FIG. 6 is a top plan view of the diffuser of FIG. 5.

FIG. 7 is a side elevational view of the recycling system of the embodiment of FIG. 1 extracted from the tank.

FIG. 8 is a side elevational view of the base support member of the embodiment of FIG. 1 extracted from the tank.

FIG. 9 is an isometric view of the base support member of FIG. 5.

FIG. 10 is an exploded view of the tank of FIG. 1 showing the trickle filter elements 40, 41 and 42.

FIG. 11 is a cross sectional view along the lines 11-11 of the tank of FIG. 1.

### DETAILED DESCRIPTION

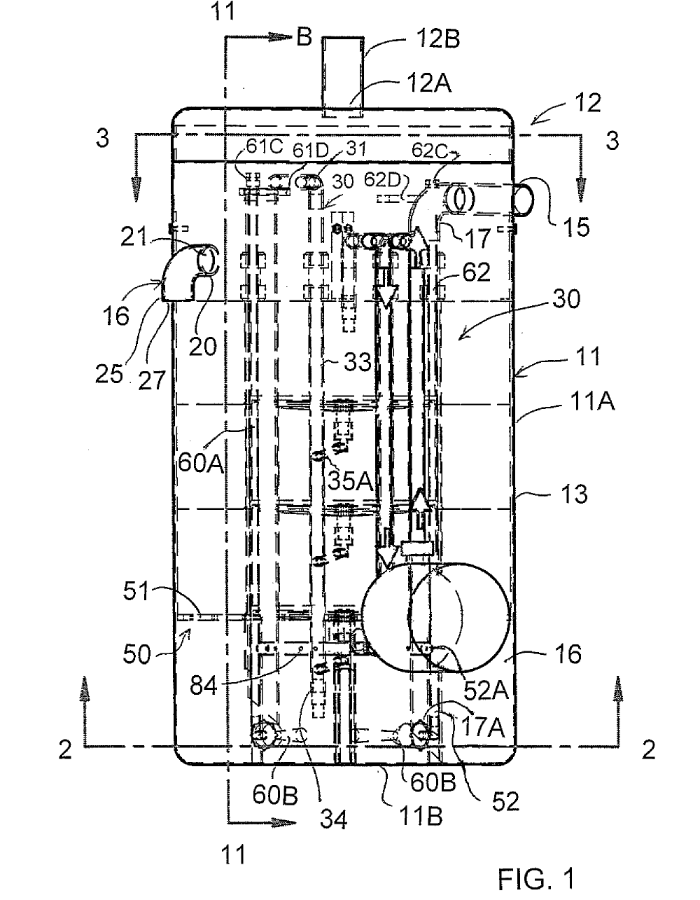

In FIGS. 1, 2 and 3 is shown water treatment tank 11 for treating waste water in a septic system. The system may include the treatment tank 11 as one of a series of septic tanks arranged sequentially. Thus a first tank 10 can comprise a conventional septic tank and receives effluent from a waste system such as a building waste system or a series of buildings or other source of contaminated water. The treatment tank 11 receives the water from the tank 10 after the extraction of substantially all of the solids so that the tank 11 is intended to attend to removal of contaminants including bacteria.

The system may include a third tank (not shown) into which the effluent is transported downstream of the treatment tank 11 of FIG. 1. This third tank may include a bed of silica sand acting as a medium for ferric oxide which is a known treatment chemical having a known action. These elements are not shown since they are well known to one skilled in the art.

The effluent at discharge 16 from the treatment tank 11 can in some systems be transmitted directly to a field. In view of the aeration system used herein, which can be used in addition to a conventional septic tank system, the septic field may be of reduced dimensions since the material fed to the field is more highly treated. Alternatively the field may be omitted altogether and the treated water used directly, depending on the amount of treatment and the end use intended.

The tank shown in the figures comprises a basic cylindrical tank structure generally indicated at 11A having a circular bottom wall 11B and upstanding cylindrical wall 13 together with a top closure 12 which closes the wall 13 to form an enclosed tank. The tank shown is cylindrical surrounding a vertical axis but of course it can be of other cross sectional shapes as required. The material from which the tank is formed can be selected in accordance with conventional engineering practice but is preferably a plastics or fibre reinforced plastics material which is relatively light and simple to construct.

The effluent is introduced from the septic tank 10 through an inlet entrance defined by a supply pipe 15 into the aeration tank 11. The supply pipe 15 transports the liquid through an opening adjacent the top of the tank with the pipe descending in a vertical portion 17 inside the tank to a discharge mouth 17A of the pipe 17 within a receiving section 16 at the bottom 11B.

When the tank is filled to a level 20, the effluent discharges from the tank through an opening 21 which is controlled by the discharge pipe 16. Thus any additional liquid fed through the feed duct 15 causes overflow through the opening 21 and the pipe 16. The discharge pipe 16 includes a depending portion 25 located outside the tank. A bottom opening 27 of the pipe allows the liquid to be discharged to a suitable location depending upon the complexity of the system to be used.

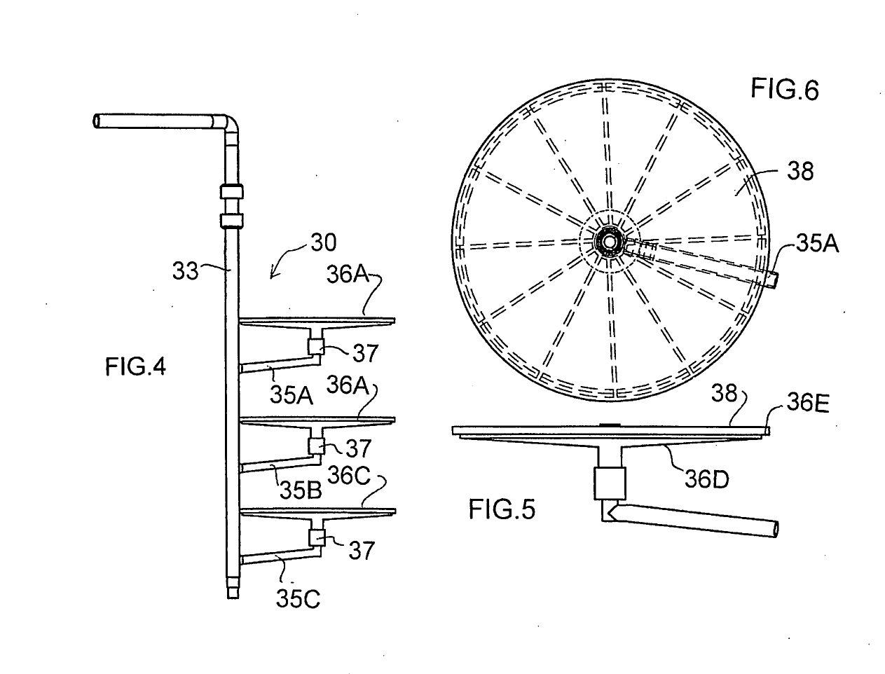

An aeration system 30 is provided and mounted within the tank within a central cylindrical section of the tank surrounding the axis of the tank. The aeration system is shown in more detail in FIGS. 4, 5 and 6 extracted from the tank for convenience of illustration.

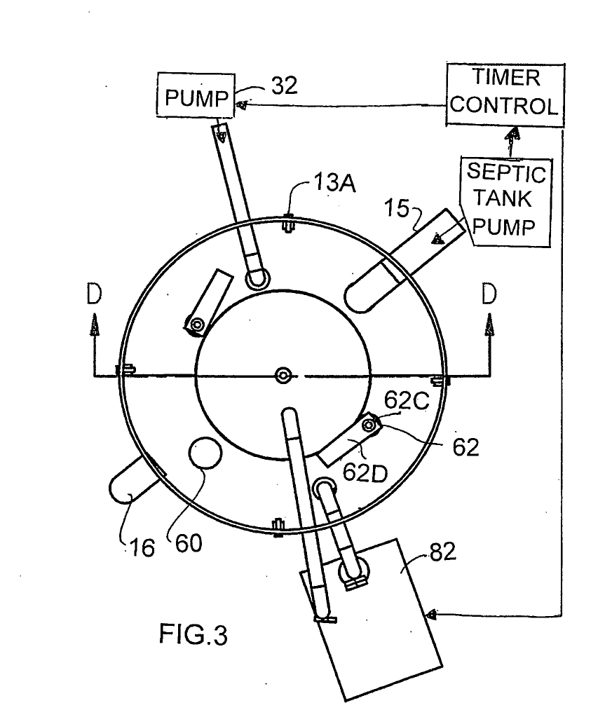

A peripheral edge of the central area of the tank is indicated in FIG. 3 at 11C which defines an annular area 11D between the cylindrical peripheral edge 11D and the wall 13.

Air from a pump 32 is pumped into a feed pipe 33 as a feed stream of aeration air. The pipe includes a first horizontal portion 31 entering the tank through a side opening and a vertical portion 33 depending within the tank to a lower end 34 within the receiving section 16. The pipe 33 supplies a series of generally horizontal pipes 35A, 35B, 35C each located within the tank. Each pipe communicates with a respective air diffusion member 36A, 36B, 36C of a stack of the members at the center of the tank.

Each pipe includes a back check valve 37 just behind the member 36 to prevent back flow of liquid into the air supply system when the pressure is removed.

Each air diffusion member comprises a circular pan 36D with an open top over which is placed a membrane 38. The pans are circular in plan with an outer diameter equal to the diameter of the central area at the edge 11D. Such air diffusion members are commercially available and include a seat with a membrane over the seat at the bottom of the pan which collapses onto the seat and lifts away from the seat as air is introduced into the base portion or pan. Each air diffusion member receives air from pipe 35. In the example shown there are three members 36 stacked one above the next at a center cylindrical area of the tank leaving an annular space outside the center area. However the number can be varied and particularly may be reduced in view of the high efficiency of the air diffuser members.

Each discharge mouth and its associated membrane extends across the open center cylindrical area of the tank for injecting the bubbles across the full width. Above each air diffusion member is located a baffle 38 or collector which engages the bubbles rising from the member below.

The purpose of this arrangement is that the bubbles when they are formed as the air exits the discharge openings 38 are small bubbles in large numbers thus providing the maximum surface area for the volume of air involved. However as the bubbles rise in the liquid they tend to expand due to the reduction in pressure and also the bubbles conjoin with the next adjacent bubbles so that the bubbles rapidly become significantly increased in volume so that the total surface area decreases. In order therefore to maintain the bubbles at the very small sizes, larger bubbles are transported out of the stream by collecting underneath the baffle defined by the bottom of the pan which is next adjacent above the bubbles and are carried to the cylindrical periphery of the center area of the tank where they can leave the center area without interfering with other small bubbles which are being formed from the next adjacent pipe.

The pipes and air diffusion members are preferably manufactured of a plastics material which is resistant to corrosion. The air diffusion members are located within the tank below the level of the liquid.

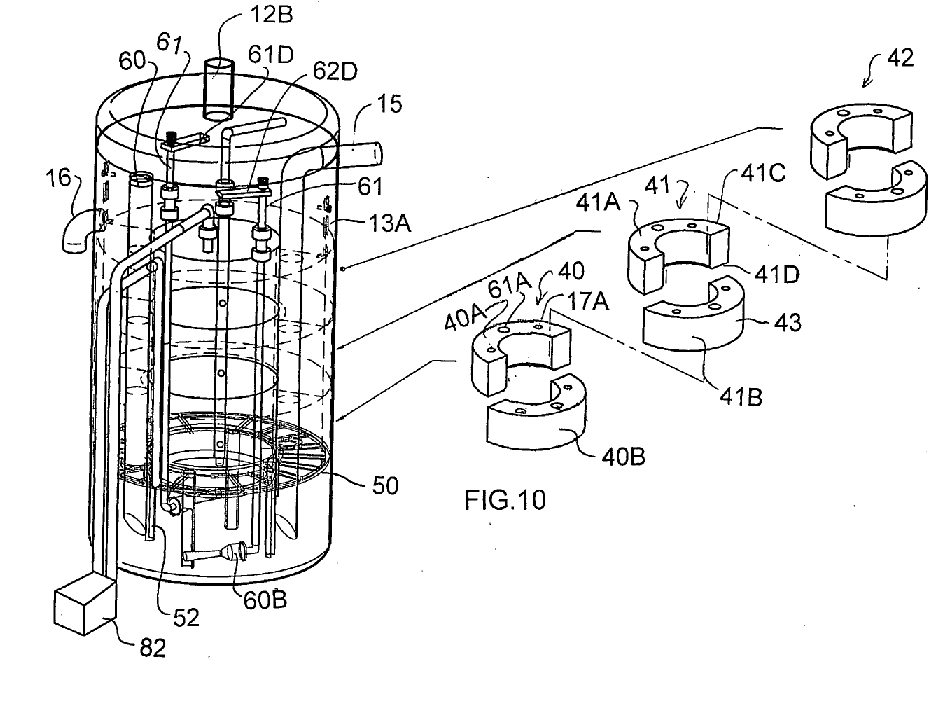

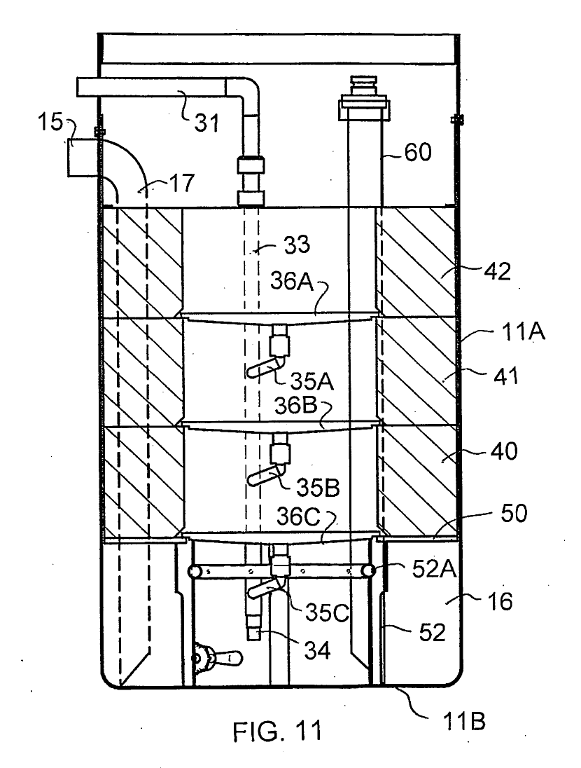

In FIGS. 1 and 10 is shown a series of trickle filter elements 40, 41 and 42. Each forms an annular member of filter medium at the side wall 13 standing along the side wall and surrounding the center area 11D to receive the air and the liquid carried thereby which moves to the side wall 13 from the center area. The trickle filter medium is made a material formed of injection molded honey-comb. Such material is commercially available in a sheet which is cut to the required shape that is part cylindrical or one half of an annular construction. The elements when cut to shape and the necessary holes drilled are stacked around the axis and so that the elements are suspended in the liquid. The honeycomb medium contains the biomass, a colony of bacteria that stabilizes the waste water or the effluent by growing on the honey comb medium and receiving food from the liquid and air from the collected bubbles necessary for growth. The biomass continually dies, sloughs off the medium and collects at the bottom of the tank so that eventually the bottom of the tank will need to be pumped out. The medium in the vertical stack of annular cages are located in the tank where the liquid and bubbles collect, as carried outwardly by the collectors 38. The elements are typically molded to define a collection of surfaces which allow passage of the liquid without restriction but provide enough surface area to carry the biomass. The stack of the part cylindrical members 36A, 36B and 36C are placed one on top of the next with a total height to a position above the top one of the aeration members 25. A plurality of angularly spaced hold down members 13A are attached to the wall 13 at spaced positions around the tank so as to engage a top surface of the top trickle filter member. In order to more easily manufacture the members and to insert them into the tank as a loose fit around the inside of the wall 13, these are formed in half sections 40A and 40B each extending around 180 degrees of the wall.

As shown in FIG. 1 the cover 12 of the tank includes a central top opening 12A at which is provided a duct 12B so that the collecting air which has passed through the liquid can be ducted to a required discharge location rather than being released into the atmosphere at the tank. This arrangement can be used to duct the air which may be noxious in quality to a remote location for discharge.

In one example, when the system is operating the tank will be filled with approximately 1 to 5% of the volume, by aeration bubbles so that the volume in the tank may rise by a couple of inches. Fresh air is supplied at every level of the air diffusion members.

The liquid also flows upwardly in the tank due to the inflow and the overflow out of the top of the tank and thus moves in labyrinthine fashion into the zones between the open center area and the filter medium surrounding the center area.

Because this form of diffusion member generates a higher number of and total volume of air bubbles across the full area of the tank, the number of stages may be reduced to only one or may be as many as two or three.

The cylindrical tank in this arrangement can be closed at the bottom and side wall below the water level to avoid penetrations which can leak. Inside the tank is located the air diffusion members and the filter members in a stack so that they can be assembled from the top.

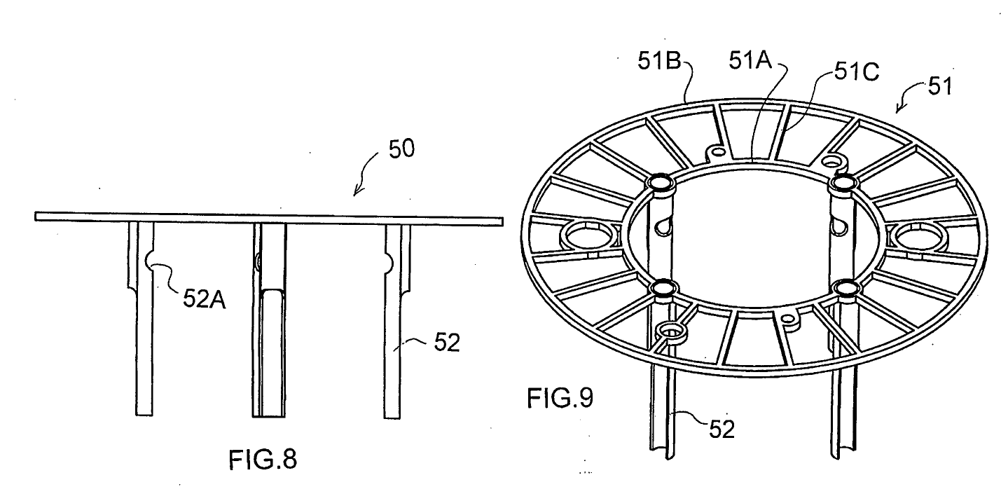

At the bottom is provided a bottom support bracket 50, shown separated from the tank in FIGS. 8 and 9, with a series of legs 52 carrying a support ring member 51 extending around the tank. This ring member defines the top of the bottom receiving section 16 into which the liquid is fed. The ring member 51 as best shown in FIG. 9 includes an inner ring 51A, and outer ring 51B and a plurality of radial bars 51C, and provides a bottom support of the bottom filter member 40 defining the filter medium. The ring 51A also supports and locates the bottom one of the three air diffusion members 36 so that it is held in place in the circular center area of the tank.

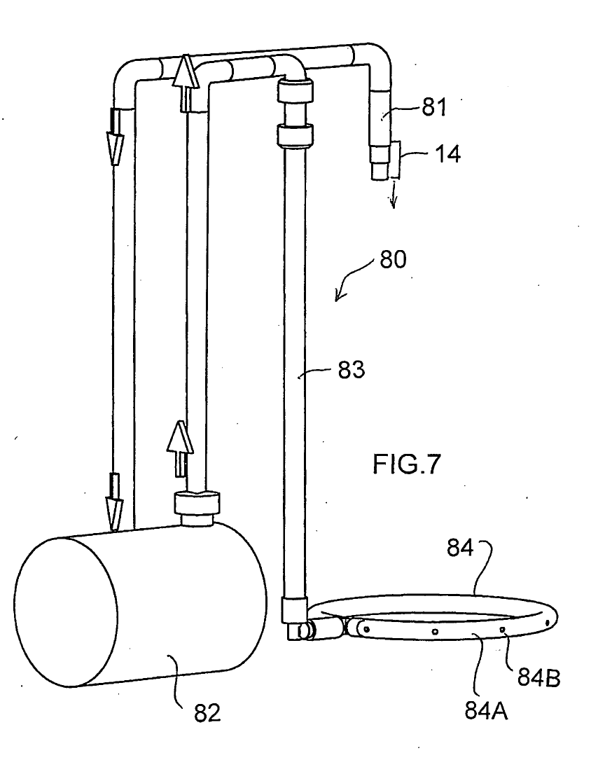

As shown in FIGS. 1, 2 and 3 and separately in FIG. 7, there is provide a recirculation system 80 for recirculating the liquid within the tank. This comprises an inlet pipe 81 which takes liquid form above the top diffuser and inside the central area, a pump 82 and a return pipe 83. The pump is mounted outside the tank and includes connecting pipes from the inlet 81 and the return 83. The return pipe 83 includes a vertical portion extending to the receiving section 16 below the ring member 51 and a dispensing arrangement 84 is provided for discharging the returned liquid around the section 16. In the embodiment shown this is in the form of an annular pipe 84A with perforations 84B allowing the liquid to escape at spaced positions around the section 16. As shown in FIG. 8, the legs 52 each include an indentation 52A on the inner surface to locate the annular pipe 84A. In other arrangements (not shown), the dispensing arrangement can be formed as separate nozzles arranged at spaced positions around the section 16.

A chemical injector 14 is located on the pipe 81 at its lower end so as to inject chemicals into the liquid in the tank at the upper end closely adjacent the pipe 81. In this way the chemicals are mixed with the liquid and drawn into the pipe 81 to pass around the recirculation system to effect a thorough mixing action. The injection system is provided for adding into the liquid to be treated any one or more of known treatment chemicals such as ferric oxide. The injector can be metered and timed as described hereinafter to inject a dose of the chemicals as the batch of liquid to be treated is fed to the tank.

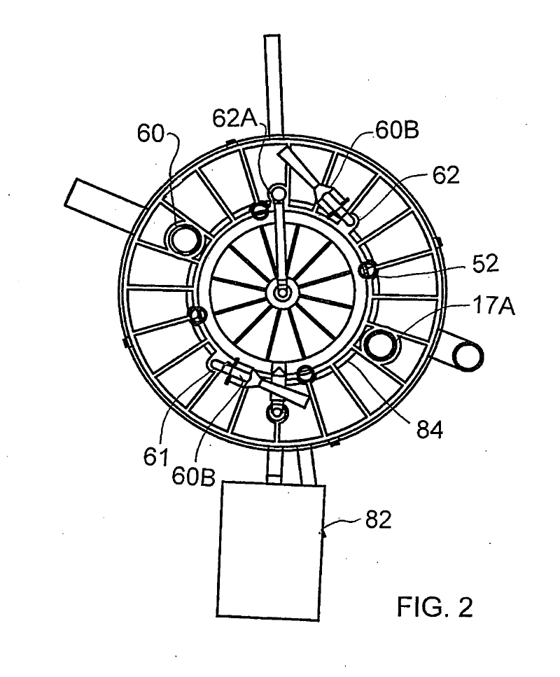

As best shown in FIGS. 2 and 10, the filter members 40, 41 and 42 have an inner cylindrical wall 41A at the periphery of the center area, an outer cylindrical wall 41B at the wall 13 so as to define the annular area therebetween and include a top wall 41C and bottom wall 41D. The members are stacked in an aligned manner.

The trickle filter members have aligned holes 17A formed through the top wall and bottom wall for the pipe 17 so that the pipe 17 extends down through the members outside the center area but within the tank 11. The top and bottom walls also have holes 60 for a pump out duct 60A extending from the bottom sump 16 to a remote pump for cleanout. The plates also have holes 61A and 62A for a liquid pressure pipes 61 and 62 which also extend into the bottom receiving area 16 so that high pressure washing liquid can be injected in a cleaning action using a bottom spray nozzle 60B. The plates 53 also have holes 30A for the air supply pipe 33. The pipes pass through the openings in the container 54 and through the particulate filter medium contained therein. The pipes 35 from the supply duct 30 extend radially inwardly from the pipe 30 through the wall 56. The pipes 61 and 62 terminate at the top of the tank below the top cover with a coupling 61C and 62C respectively for connection to conventional supply conduits from a conventional pump out truck. Each pipe 61, 62 is connected at its upper end to a horizontal handle 61D, 62D which can be rotated around the vertical axis of the pipe to move the bottom nozzle around the section 16 to effect clean out of any collecting solids and sludge.

Important features of the arrangement are as follows:

a) the air feed system 30 includes an air pump 32 and air supply line 33 for feeding air into the air diffusion members for discharge of the air into the liquid as bubbles of the air in the liquid;

b) The baffle across the center area acts to collect and guide bubbles rising from the air diffusion member and directs the air outwardly to the trickle filter medium;

c) the trickle filter medium contains a biomass and receives the air bubbles from the baffle guided by the collecting member;

d) the filter medium is arranged along at least one side of the tank and in the embodiment shown is arranged around all sides so as to fully surround the bubble section in the center area;

e) the collecting member is arranged to direct air bubbles and liquid into the surrounding filter medium which is then caused to flow back out of the filter medium above the collecting member back into the center area;

In operation, the tank is arranged to receive a batch of liquid for treatment from the source which batch is communicated through the supply pipe to the receiving section. There is provided a timer 90 responsive to the supply of a batch of liquid and arranged to time operation of the recirculation pump 82 and the air pump 32 for a pre-determined time period. These time periods can be varied and can be different. It is intended that the times be sufficient for the treatment of the liquid supplied to the tank 11. The timer is actuated by a level sensing signal from the septic tank 10 which detects when the discharge from the tank 10 is required to pump out a batch of fluid from that tank to reduce the level. Typically the amount pumped in a household system might be 35 gallons. When the level detector senses that a batch should be discharged, the control unit, before the pump is actuated to discharge that amount, activates the air pump to aerate the tank 11 for a predetermined time period of a few minutes, typically 5 minutes. After that time is elapsed, the liquid pump is actuated to transfer the batch into the tank 11 thus raising the liquid level above the discharge opening 20. The liquid pump is halted when the batch is transferred as determined by the level sensor. The air pump and the recirculation pimp continues to run after the liquid pump is halted to continue the aeration process for a further predetermined time period again of the order of a few minutes. The liquid which has been added into the tank 11 elevates the top level thus causing liquid to discharge through opening 20 by gravity until the level falls below the opening. The size of the opening 20 is selected so that a required amount of the liquid is recycled relative to that discharged through opening.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. Apparatus for aeration of liquid comprising:
a tank for receiving the liquid from a source having a tank top, a tank bottom and tank sides for receiving and containing a quantity of the liquid during aeration;
the tank having a receiving section adjacent the tank bottom and a discharge section adjacent the tank top;
a liquid supply pipe for transporting the liquid from the source into the tank arranged to discharge the liquid into the receiving section adjacent the tank bottom;
a discharge duct for removing liquid from a top of the tank to maintain a desired level of the liquid in the tank;
at least one air diffusion member in the tank above the receiving section and below the level of the liquid so that said at least one air diffusion member is located in the liquid in the tank;
an air feed system including an air pump and air supply line for feeding air into said at least one air diffusion member for discharge of the air into the liquid as bubbles of the air in the liquid;
at least one collecting member arranged to collect and guide bubbles rising from said at least one air diffusion member;
and at least one trickle filter medium arranged to contain a biomass, the filter medium being arranged in the tank at a location therein to receive the air bubbles from said at least one air diffusion member guided by the collecting member.

2. The apparatus according to claim 1 wherein the filter medium is arranged along at least one side of the tank.

3. The apparatus according to claim 1 wherein at least one of the air diffusion members is located in the tank above a bottom collecting member so as to discharge the air as bubbles into the liquid from which the bubbles of bottom one of the diffusion members have been removed by the bottom collecting member.

4. The apparatus according to claim 1 wherein said at least one collecting member is arranged at a center of the tank and is arranged to direct the collected air outwardly to each side of the tank.

5. The apparatus according to claim 1 wherein the at least one air diffusion member is arranged in a center area with the filter medium arranged to surround the center area.

6. The apparatus according to claim 5 wherein the air diffusion member is circular and defines a circular center area and the filter medium is cylindrical surrounding the center area.

7. The apparatus according to claim 1 wherein the collecting member is arranged to direct air bubbles and liquid into the surrounding filter medium which is then caused to flow back out of the filter medium above the collecting member back into the center area.

8. The apparatus according to claim 1 wherein the filter medium comprises a plurality of part cylindrical members arranged in an array which surrounds the air diffusion member and the collecting member.

9. The apparatus according to claim 8 wherein the part cylindrical members have vertical holes for passage of an air supply duct to the air diffusion member and the liquid supply pipe.

10. The apparatus according to claim 1 wherein there is provided a bottom pump out pipe extending from the receiving section at the bottom of the tank and at least one pressure cleaning pipe extending to the receiving section.

11. The apparatus according to claim 10 wherein said at least one pressure cleaning pipe has a directional nozzle which can be adjusted manually from the top of the tank by rotating the cleaning pipe around its axis.

12. The apparatus according to claim 1 wherein the tank is arranged to receive a batch of liquid for treatment from the source which batch is communicated through the supply pipe to the receiving section and wherein there is provided a recirculation system including a recirculation pump for collecting liquid from the discharge section and returning it to the receiving section.

13. The apparatus according to claim 12 wherein there is provided a timer responsive to the supply of a batch of liquid and arranged to time operation of the recirculation pump and the air pump for a pre-determined time period.

14. The apparatus according to claim 12 wherein the recirculation system includes a return supply system arranged to effect discharge at positions around the receiving section.

15. The apparatus according to claim 1 wherein there is provided a support floor for the trickle filter medium located above the receiving section.

16. The apparatus according to claim 1 wherein there is provided a chemical injection system for supplying treatment chemicals into the supply pipe.

17. The apparatus according to claim 16 wherein the treatment chemicals comprise ferric oxide.

18. The apparatus according to claim 1 wherein there are provided back check valves in the air supply line at the air diffusion member.

19. Apparatus for aeration of liquid comprising:
a tank for receiving the liquid from a source having a tank top, a tank bottom and tank sides for receiving and containing a quantity of the liquid during aeration;
the tank having a receiving section adjacent the tank bottom and a discharge section adjacent the tank top;
a liquid supply pipe for transporting the liquid from the source into the tank arranged to discharge the liquid into the receiving section adjacent the tank bottom;
a discharge duct for removing liquid from a top of the tank to maintain a desired level of the liquid in the tank;
at least one air diffusion member in the tank above the receiving section and below the level of the liquid so that said at least one air diffusion member is located in the liquid in the tank;
an air feed system including an air pump and air supply line for feeding air into said at least one air diffusion member for discharge of the air into the liquid as bubbles of the air in the liquid;
and at least one trickle filter medium arranged to contain a biomass;
wherein the at least one air diffusion member is arranged in a center area of the tank with the trickle filter medium surrounding the center area.

20. Apparatus for aeration of liquid comprising:
a tank for receiving the liquid from a source having a tank top, a tank bottom and tank sides for receiving and containing a quantity of the liquid during aeration;
the tank having a receiving section adjacent the tank bottom and a discharge section adjacent the tank top;
a liquid supply pipe for transporting the liquid from the source into the tank arranged to discharge the liquid into the receiving section adjacent the tank bottom;
a discharge duct for removing liquid from a top of the tank to maintain a desired level of the liquid in the tank;
at least one air diffusion member in the tank above the receiving section and below the level of the liquid so that said at least one air diffusion member is located in the liquid in the tank;
an air feed system including an air pump and air supply line for feeding air into said at least one air diffusion member for discharge of the air into the liquid as bubbles of the air in the liquid;
wherein the tank is arranged to receive a batch of liquid for treatment from the source which batch is communicated through the supply pipe to the receiving section and wherein there is provided a recirculation system including a recirculation pump for collecting liquid from the discharge section and returning it to the receiving section.

21. The apparatus according to claim 20 wherein there is provided a timer responsive to the supply of a batch of liquid and arranged to time operation of the recirculation pump and the air pump for a pre-determined time period.
